(19) United States
(12) Patent Application Publication
(10) Pub. No.: US 2008/0296098 A1
(43) Pub. Date: Dec. 4, 2008

(54) Brake Shoe for Elevator Emergency Stop

(75) Inventors: Goro Sato, Kasumigaura (JP); Takahiko Sawada, Hitachinaka (JP); Masato Nakayama, Tsuchiura (JP); Takashi Teramoto, Kasumigaura (JP); Koichi Miyata, Kasumigaura (JP); Mitsugu Omori, Hitachinaka (JP); Hidetaka Zama, Hitachinaka (JP); Toshihiko Gotoh, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/132,647

(22) Filed: Jun. 4, 2008

(30) Foreign Application Priority Data
Jun. 4, 2007 (JP) 2007-147610

(51) Int. Cl. B66B 5/16

(52) U.S. Cl. 187/376

(57) ABSTRACT

The present invention prevents cracking of a brake shoe even when the sliding surface of the brake shoe is heated to a high temperature and provides high reliability. The present invention provides a brake shoe for elevator emergency stop which generates a braking force by pressing brake shoes against a guide rail and making the brake shoes 5 slide to stop an elevator cage in the event of anomalies, including the brake shoes made of a cast iron material having a plurality of grooves 3 formed in a direction substantially perpendicular to the guide rail and gear teeth which constitute a sliding surface with the brake shoes 5 formed as gaps between the grooves, wherein the depth of the grooves is 3 mm or more and not more than 1.7 times the width of the gear teeth.

### BACKGROUND OF THE INVENTION

The present invention relates a brake shoe for elevator emergency stop for and is particularly suitable as a brake shoe operated when the elevator speed reaches or exceeds a predetermined speed.

It is obligatory to provide an elevator with a safety gear, that is, a brake shoe for elevator emergency stop to stop a cage at appropriate deceleration when the cage descends at a predetermined or higher speed.

The safety gear uses a shoe with two trapezoidal friction members arranged inside surrounded by an elastic body and presses an elevator guide rail set on the wall of a hoist way with the two shoes when the cage reaches the predetermined or higher speed. The safety gear then generates a braking force using a force originating from elastic deformation of the elastic body and the shoe is conventionally formed of a cast iron material having an appropriate coefficient of friction and wear resistance in many cases.

The safety gear using a cast iron material is provided with a shoe including a plurality of grooves on a sliding surface with the guide rail. This groove is intended to exclude wear powder generated by frictional sliding with the guide rail during emergency braking from the sliding surface, secure the coefficient of friction of the sliding surface and prevent the wear powder or fragments from breaking into the guide rail causing the shoe from being abnormally worn and such a safety gear is described, for example, in JP-A-2006-131384.

Furthermore, another safety gear is known to divide a ceramic friction member having excellent heat resistance and bury the ceramic friction members in the shoe body so as to obtain a stable frictional force even when a large amount of frictional heat is generated between the shoe and guide rail and such a safety gear is described, for example, in JP-A-2000-191252.

As buildings become more and more multistoried, elevator specifications are also required to meet demand for increasing speeds and capacities and safety gears are required to secure stable frictional force even under a high temperature environment due to frictional heat generated between the shoe and guide rail during operation.

As a result of increasing amount of heat generated on the sliding surface caused by increases in speed and capacity, conventional techniques using cast iron involve a danger that the shoe may be split from the bottom of the grooves on which stress is concentrated because of thermal stress acting on the vicinity of the sliding surface.

Furthermore, the use of a ceramic friction material having excellent hest resistance for the shoe can secure the strength of the friction material, but the material cost of ceramics is over ten times that of cast iron and the structure of fastening with the shoe is complicated, leading to drive up the cost of the entire apparatus. Furthermore, since ceramics is a brittle material, compared to the cast iron material, securing predetermined quality thereof requires stringent process management and requires extreme caution during machining and assembly.

It is an object of the present invention to solve the aforementioned problems of the conventional techniques and provide a brake shoe for elevator emergency stop which makes handling easier with simple management, suppresses the apparatus cost, prevents cracking even when the sliding surface of the shoe is heated to high temperature, capable of reliably stopping the cage in emergency, thus providing high reliability.

### BRIEF SUMMARY OF THE INVENTION

In order to attain the aforementioned object, the present invention provides a brake shoe for elevator emergency stop which generates a braking force by pressing shoes against a guide rail and making the shoes slide to stop an elevator cage in the event of anomalies, including the shoe made of a cast iron material having a plurality of grooves formed in a direction substantially perpendicular to the guide rail and gear teeth which constitute a sliding surface with the shoe formed as a gap between the grooves, wherein the depth of the grooves is 3 mm or more and not exceeding 1.7 times the width of the gear teeth.

According to the present invention, the shoe is made of a cast iron material and the grooves whose depth is 3 mm or more and not exceeding 1.7 times the width of the gear teeth are formed, and it is thereby possible to prevent thermal stress acting on the groove bottom from exceeding a yield point of the shoe material and also prevent bending stress at the groove bottom from exceeding tensile strength. Therefore, even when a cast iron material is used, it is possible to prevent cracking in a high temperature environment in which the temperature of the sliding surface of the shoe is higher than 1000° C. and reliably stop the cage in the event of an emergency, thus providing high reliability.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is a perspective view of a shoe which is an embodiment according to the present invention;

FIG. 2 is a front view showing a safety gear which is the embodiment according to the present invention;

FIG. 3 is a partial perspective view of the safety gear in FIG. 2;

FIG. 4 is a graph showing a temperature distribution versus a distance in a thickness direction of the shoe according to the embodiment;

FIG. 5 is a cross-sectional side view showing a heated area of the shoe according to the embodiment;

FIG. 6 is a diagram of stress and strain acting on the shoe according to the embodiment;

FIG. 7 is a perspective view showing a calculation model of the shoe according to the embodiment;

FIG. 8 is a cross-sectional side view showing a gear tooth in a sliding part of the shoe according to the embodiment;

FIG. 9 is a graph showing a relationship between bearing stress and a coefficient of friction of the shoe according to the embodiment; and

FIG. 10 is a side view of a shoe according to another embodiment.

### DETAILED DESCRIPTION OF THE INVENTION

Hereinafter, a brake shoe for elevator emergency stop will be explained with reference to the attached drawings.

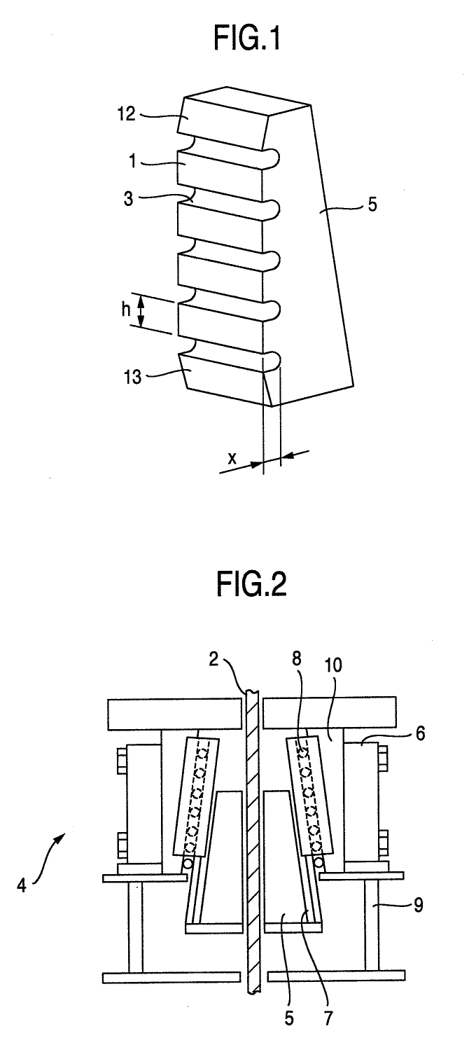

FIG. 2 is a longitudinal cross-sectional view of a safety gear and a safety gear 4 is configured to be symmetric with respect to a guide rail 2. The safety gear has a pair of shoes 5 formed so as to have a trapezoidal cross section, a top side of the brake shoe 5 corresponds to a short side and a bottom side corresponds to a long side.

The pair of brake shoes 5 is arranged substantially parallel to the guide rail 2 with a small distance therefrom to sandwich the guide rail 2. The back surface of the brake shoe 5 forms a wedge-like smooth slope which narrows toward the top.

Furthermore, a guide plate 8 for guiding the brake shoe 5 is provided for a guide member 10 so as to move the brake shoe 5 to a predetermined position. The inside of the guide member 10 forms a slope parallel to the slope of the brake shoe 5 and the outside thereof forms a vertical surface and the vertical surface is sandwiched by an elastic body 6. The perimeter of the guide member 10 is surrounded by the U-shaped elastic body 6, the side facing the guide rail 2 of which is open. The brake shoes 5, guide plates 8, guide members 10 and elastic body 6 are housed in a housing 9 and a lifting bar of drive means (not shown) for activating the safety gear is connected to one end of the brake shoe 5.

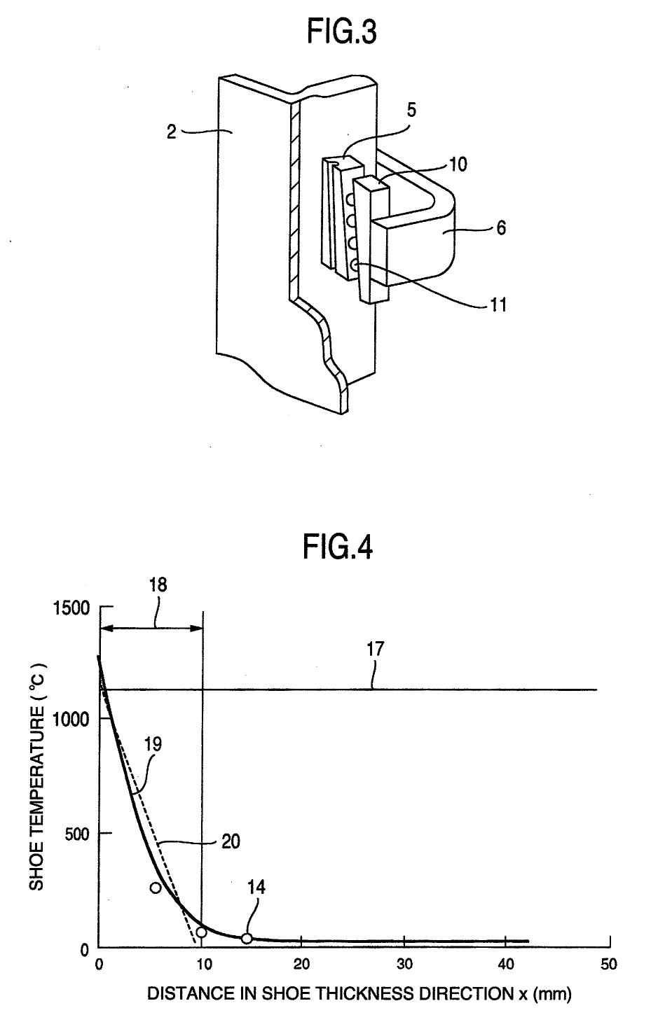

FIG. 3 shows the safety gear in operation. A plurality of guide rollers 11 are pushed against the slope of the brake shoe 5. The rollers 11 are pivotably supported to the guide member 10 and act so as to allow the brake shoe to smoothly move upward.

The guide member 10 has a slope parallel to the slope of the brake shoe 5 and the back side of the guide member 10 forms a vertical surface, and therefore the vertical surface of the guide member 10 is sandwiched by the elastic body 6. Thus, when the safety gear operates, the brake shoes 5 are lifted with respect to the guide members 10, pushing open the guide members 10. The counter force produced by pushing open the guide members 10 acts on the brake shoes 5 causing the brake shoes 5 to move so that the mutual distance is narrowed. The brake shoes 5 then sandwich the guide rail 2.

FIG. 1 is a schematic perspective view of the brake shoe. The brake shoe 5 is made of a prism-like cast iron material and a sliding surface 1 which slides on the guide rail has slopes 12 and 13 whose central part is flat and whose top and bottom are inclined in directions away from the guide rail toward their respective ends.

The sliding surface 1 is provided with grooves 3 for capturing wear powder generated during braking, discharging the wear powder out of the sliding surface 1 and preventing the wear powder and fragments from breaking into the guide rail and causing abnormal wear. A plurality of grooves 3 are formed in a direction substantially perpendicular to the guide rail. Furthermore, the groove 3 is substantially semicircular or U-shaped and designed so as to improve workability and reduce concentration of stress on the groove bottom.

The depth x of the groove is preferably set so as to minimize stress acting on the bottom of the groove 3. Furthermore, the sliding surface 1 has a structure with a plurality of convex parts and the width h of a convex gear tooth is set in accordance with the depth x of the groove.

The operation of the safety gear will be explained. When the moving speed of the cage (not shown) reaches a set speed which exceeds a rated speed, a speed sensor (not shown) set on the top floor operates, the lifting bar (not shown) lifts the brake shoes 5 and the brake shoes 5 sandwich the guide rail 2 set on walls of a hoist way on both sides of the cage. The brake shoes 5 push open the U-shaped elastic body 6 to cause elastic deformation, thereby produce a frictional force by cutting or adhesion between the guide rail 2 and brake shoes 5 and stop the cage.

Since the specification of the elastic body of the safety gear is determined by the rated speed or payload of the elevator installed, that is, braking energy carried by the safety gear, the sizes of the elastic body and brake shoes should necessarily be increased as the braking energy increases. Furthermore, the greater the braking energy, the higher the temperature of the brake shoe sliding surface becomes and a greater heat load is added. As a result, depending on the bottom position of the grooves provided in the sliding surface, stress may be concentrated on the grooves, causing the brake shoes to crack from the groove bottom.

FIG. 4 shows a temperature characteristic of the brake shoe of the safety gear attached to an elevator having a braking start speed of 650 m/min and dropping mass (formed by the cage, passenger(s), rope and so forth falling vertically downward) of 25 tons and shows the distance in the brake shoe thickness direction versus temperature immediately after braking stop.

This calculation is a result of a one-dimensional thermal conduction calculation carried out when the amount of heat corresponding to braking energy is constantly introduced from the sliding surface. Suppose eight pieces of cast iron having a sliding area of 6×10⁻³m² are used for the brake shoe (a set of upper, lower two safety gears) as the conditions for this calculation, the average deceleration during emergency stop operation is 9.8 m/s² which is an upper limit within a rated range and the amount of heat generated is distributed by ½ each to the guide rail and brake shoe. In FIG. 4, white circles denote measured values of brake shoe side temperature when a braking test is conducted under conditions similar to those described above and the calculation values substantially match the measured values.

As shown in FIG. 4, the temperature of the sliding surface exceeds approximately 1150° C. (value indicated by reference numeral 17 in the figure) which is the melting point of cast iron, but a range 18 in which the introduced heat reaches in the brake shoe thickness direction is up to approximately 10×10⁻³ m (10 mm) from the sliding surface and only the vicinity of the sliding surface is heated.

Furthermore, if a temperature characteristic 19 is approximated by a dotted line 20, temperature T (° C.) at the brake shoe thickness direction distance x (m) is expressed by Expression 3.

T=Tₘₐₓ(1−x/L) (Expression 3)

Here, Tₘₐₓ denotes the melting point of cast iron (1150° C.), L denotes a heating thickness (range in which heat reaches in the brake shoe thickness direction) 10×10⁻³ m (10 mm).

In such specifications of various elevators that the sliding surface temperature exceeds the melting point, the sliding surface temperature rises, but the range L in which the heat reaches does not substantially change. Since the melting point is an actual limit value of the sliding surface temperature, the temperature distribution becomes like the one approximated according to Expression 3.

Next, the relationship between the specification conditions of the elevator and the brake shoe surface temperature of melting point 1150° C. will be explained.

When deceleration during emergency braking is assumed to be 9.8 m/s², braking energy E (J) generated, is expressed by Expression 4. Furthermore, thermal energy Q (J) introduced into the brake shoe during braking is expressed by Expression 5.

E=mV² (Expression 4)

Q=CT (Expression 5)

Here, m is dropping mass (kg), V is braking start speed (m/s), C is heat capacity (J/K) of the brake shoe and T is brake shoe temperature (° C.).

If ½ of the braking energy E is assumed to be heat-distributed as the brake shoe temperature T, E/2=Q and if the thermal energy Q is assumed to be generated at n brake shoes, Q becomes nC(TₘₐₓL)/2 which is a value obtained by integrating the distance in the brake shoe thickness direction x from 0 to L and Tₘₐₓ becomes like the one expressed by Expression 6 according to Expressions 4 and 5.

Tₘₐₓ=mV²/nCL (Expression 6)

Here, n is the number of brake shoes. Furthermore, C=cνA assuming that c is specific heat (J/kgK) of the brake shoe, ν is a density (kg/m³) of the brake shoe and A is the area (m²) of the sliding surface of the brake shoe.

When physical property value of cast iron c=546 (J/kgK), ν=7.2×103 (kg/m³) and heating length L=10 mm are substituted into Expression 6, the specification condition of the elevator whose brake shoe surface temperature exceeds the melting point 1150° C., that is, condition Tₘₐₓ≧1150° C. is expressed by Expression 7.

mV²/An≧4.5×10⁷(J/m²) (Expression 7)

However, since the cast iron material is worn by sliding, it is difficult to use the cast iron material for a 1000 m/min class elevator and the cast iron material is preferably used for speed 1000 m/min or less.

Next, the groove depth provided for the sliding surface and width of the convex gear teeth of the sliding part are optimized from thermal stress and bending stress acting on the brake shoe of the safety gear mounted on the elevator that satisfy Expression 7.

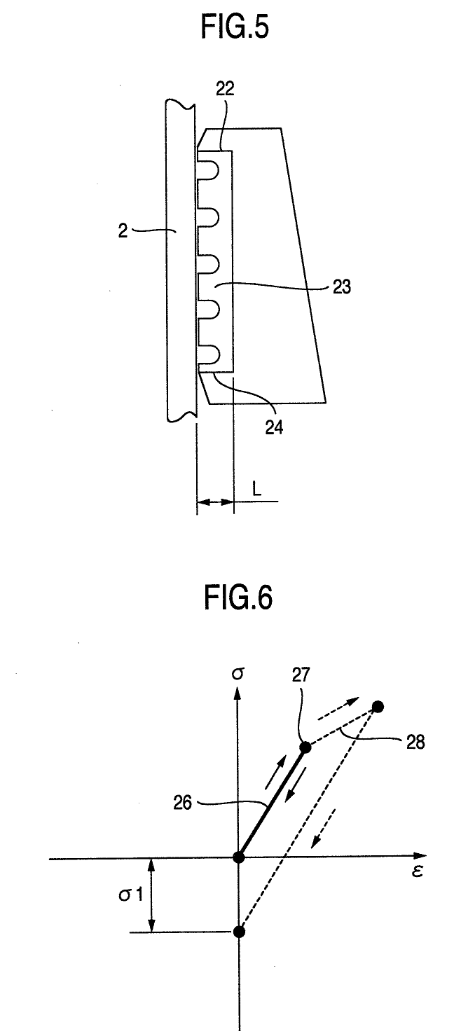

FIG. 5 shows a side view of the guide rail and the sliding brake shoe. Since the flat sliding surface in the center of the brake shoe slides while being pushed against the guide rail 2 by the elastic body, frictional heat is introduced and the temperature rises. On the other hand, since the top part and bottom part of the brake shoe have a slope inclined in a direction away from the guide rail, these parts do not slide on the brake shoe, there is substantially no temperature rise.

As shown in FIG. 4, the heating thickness L in the brake shoe thickness direction to which heat is introduced is approximately 10 mm from the braking surface. Therefore, at least 20 mm is required for the wedge thickness even at the trapezoidal top part. Therefore, the heating part 23 is only the neighborhood of the sliding surface surrounded by the top part 22, portion of the heating thickness L and bottom part 24 shown in FIG. 5. As a result, the channel-shaped portion surrounding the perimeter of the heating part 23 displays substantially no thermal expansion and constrains the heating part.

FIG. 6 shows a stress-strain diagram and when a compressive load generated by thermal expansion of the heating part 23 of the brake shoe reaches a plastic region 28 beyond a yield point 27, a tensile load σ₁ acts after cooling (after drop stop) (process shown by a dotted arrow). In this case, if the grooves are provided in the heating part, the tensile load is concentrated on the groove bottom and exceeds tensile strength of the brake shoe material, cracking may start from the groove bottom. Therefore, it is necessary to prevent the tensile load from acting on the brake shoe, and for that effect, it is preferable to limit heating expansion to within the range of the elastic region 27 (process shown by a solid arrow).

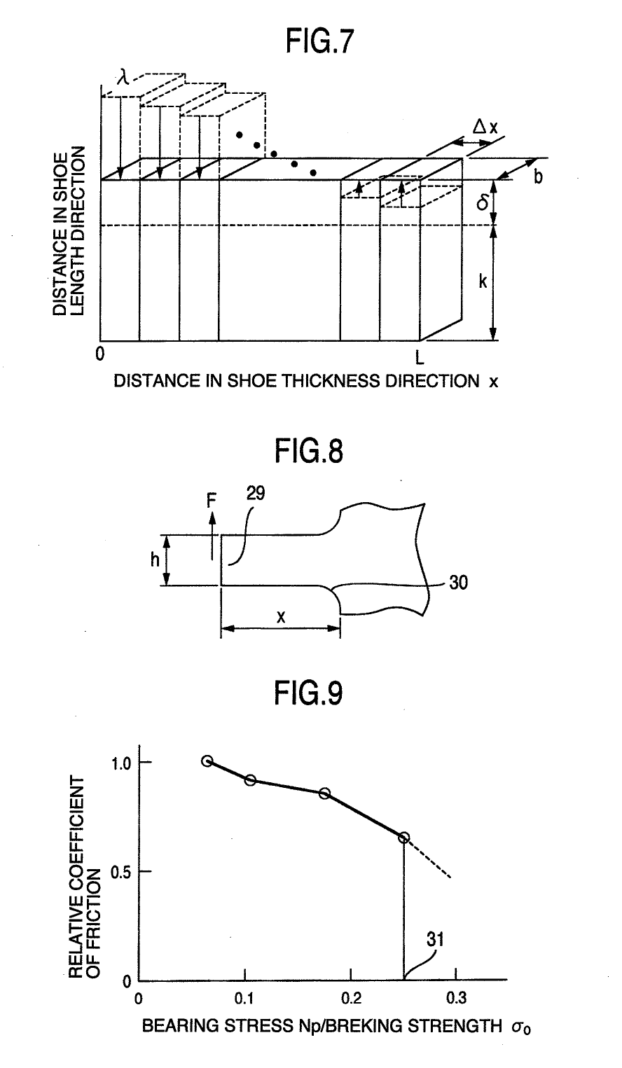

Next, a thermal stress distribution in the brake shoe thickness direction of the heated area will be calculated. FIG. 7 shows a calculation model in which the heating range of the brake shoe is subdivided in the vertical direction.

The amount of expansion λ when the brake shoe is heated without any constraint is λ=αΔTk. Here, α is a coefficient of linear expansion, ΔT is a temperature rise and k is the length of the brake shoe before thermal expansion.

Since heat is introduced only from the sliding surface, the amount of expansion is large on the sliding surface on the high temperature side as shown by the dotted line and small on the low temperature side in the thickness direction x. Furthermore, when constraint in the vertical direction is added, the amount of expansion falls within a predetermined amount of expansion over the entire thickness direction region while being affected by binding forces of mutually neighboring elements. The binding force P(N) generated in this case is expressed by Expression 8 assuming the brake shoe temperature is T.

P=Eb{αTₘₐₓ(1−x/L)k−δ}Δx/k (Expression 8)

E is Young's modulus (MPa), α is the coefficient of linear expansion (1/K), Tₘₐₓ is the melting point of cast iron (1150° C.), L is the heating thickness 10 mm, k is the length (m) of the brake shoe before thermal expansion, δ is the amount of expansion (m), Δx is the element length (m) in the brake shoe thickness direction and b is the width (m) of the brake shoe.

Since the total binding force Pₜₒₜₐₗ is a value obtained by integrating Expression 6 from the sliding surface to the heating thickness L and the sum total of internal forces, Pₜₒₜₐₗ=0. Therefore, the length δ of the brake shoe after thermal expansion is expressed by Expression 9.

δ=αTₘₐₓk/2 (Expression 9)

When Expression 9 is substituted into Expression 8, the binding force P is expressed by Expression 10.

P=EbαTₘₐₓ(½−x/L)Δx (Expression 10)

Since stress σ (MPa) generated is P/Δxb, σ is expressed by Expression 11.

σ=EαTₘₐₓ(½−x/L) (Expression 11)

To confine the thermal expansion of the brake shoe within the range of the elastic region, a relationship of stress σ generated at the position of the groove bottom, that is, at the groove depth x<yield point σa of brake shoe material must be established, and therefore the relationship may be expressed by Expression 12.

x>(1−2σa/EαTₘₐₓ)/200 (Expression 12)

Next, an upper limit of the groove depth will be explained.

FIG. 8 is a cross-sectional side view of the convex structure of the sliding part of the brake shoe (hereinafter referred to as “gear tooth”). During emergency stop braking, a frictional force in a direction indicated by an arrow F acts on the sliding surface of the gear tooth 29. Therefore, largest bending stress σ2 acts on a gear tooth root 30. Suppose the upper limit of the groove depth is a condition for bending stress σ2<brake shoe tensile strength σ_{B}.

In FIG. 8, the bending stress σ2 generated at the gear tooth root 30 is expressed by Expression 13.

σ2=6μₘₐₓNx/bh² (Expression 13)

μₘₐₓ is a maximum coefficient of friction acting between the guide rail and brake shoe, N is an elastic body counter force (N) per gear tooth, x is a groove depth (m), b is a brake shoe width (m) and h is a height of the gear tooth (m). Therefore, to obtain σ2<σ_{B}, the groove depth x may be preferably set as expressed in Expression 14.

X<σ_{B}bh²/6μₘₐₓN (Expression 14)

Furthermore, the elastic body counter force N (N) per brake shoe to secure average deceleration 9.8 (m/s²) may be set as expressed in Expression 15.

N=2 mg/nμₐᵥᵣ (Expression 15)

m is dropping mass (kg), g is acceleration of gravity (m/s²), n is the number of brake shoes, μₐᵥᵣ is an average coefficient of friction acting between the guide rail and brake shoe.

Furthermore, when the number of gear teeth per brake shoe is assumed to be e, since the bearing stress of the brake shoe Np (MPa)=N/ebh, the groove depth x(m) may be converted as expressed in Expression 16.

X<σ_{B}h/6μₘₐₓNp (Expression 16)

FIG. 9 shows a variation of the coefficient of friction versus the brake shoe bearing stress Np obtained through an experiment. The bearing stress Np is a relative value corresponding to the tensile strength of the brake shoe σ_{B} (MPa) and the coefficient of friction is expressed converted to a relative value using the coefficient of friction equivalent to or less than 1/10 of the tensile strength σ_{B} as a reference value 1.0. As shown in FIG. 9, when bearing stress Np/tensile strength σ_{B} is ¼ or greater (position indicated by reference numeral 31 in the figure), the coefficient of friction drastically reduces.

From above, the upper limit of the bearing stress Np is preferably set to approximately ¼ of the tensile strength σ_{B}. Expression 16 is converted based on this and the groove depth x may be 2 h/3μₘₐₓ or less as expressed in Expression 17.

x<2h/3μₘₐₓ (Expression 17)

In conclusion, when the value of mV²/nA is assumed to be 4.52×107 (J/m²) or more in the specification of the elevator, a cast iron material is used for the brake shoes of the safety gear, the groove depth x of the grooves provided in the sliding surface that slides on the guide rail is set to be greater than (1−2σa/EαTₘₐₓ)/200 and smaller than 2h/3μₘₐₓ, that is, set to a range that satisfies the following expression, and it is thereby possible to secure the strength that can withstand thermal stress and bending stress.

(1−2σa/EαTₘₐₓ)/200<x<2h/3μₘₐₓ (Expression 18)

Furthermore, when a cast iron material having strength equivalent to FCD400 is selected, suppose the groove depth x is 3 mm or more and equivalent to or less than 1.7 times of the gear teeth width, assuming that the yield point σa=250 (MPa), Young's modulus E=1.6×10⁵ (MPa), coefficient of linear expansion α=1×10⁵ (1/K), cast iron melting point Tₘₐₓ=1150(° C.) and maximum coefficient of friction μₘₐₓ=0.4.

Furthermore, the gear tooth width h of the sliding surface is preferably h=5×10⁻³ (m) and the groove depth x in this case may be greater than 3×10⁻³ m and smaller than 8×10⁻³ m from Expression 18 (3 mm<x<8 mm).

Furthermore, the groove width is preferably wider to facilitate discharging cutting powder and reduce concentration of stress on the groove bottom. Furthermore, increasing the number of grooves also facilitates discharging of powder.

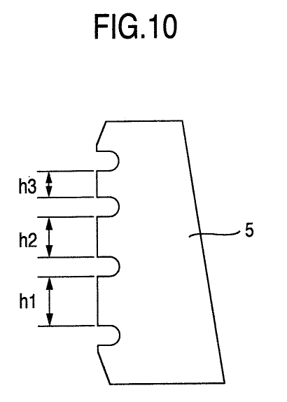

FIG. 10 shows an example of the shape of the brake shoe where the start gear tooth is wider than the following gear teeth of the sliding surface that slides on the guide rail (gear tooth width h1>gear tooth width h2, gear tooth width h1>gear tooth width h3). In this way, the start gear tooth (lower part in the figure) always slides on a new surface of the guide rail and, thereby receives the greatest frictional force, thus making it possible to widen the gear teeth of the portion subject to a large frictional force, secure a substantial sliding area and provide more grooves without increasing the size of the brake shoe. Therefore, it is possible to facilitate discharging of cutting powder and prevent wear powder and fragments from breaking into the guide rail and causing abnormal wear. Furthermore, if the groove depths of the respective grooves are assumed to be the same, it is possible to facilitate work and prevent cracking of the groove bottom.

It should be further understood by those skilled in the art that although the foregoing description has been made on embodiments of the invention, the invention is not limited thereto and various changes and modifications may be made without departing from the spirit of the invention and the scope of the appended claims.

1. A brake shoe for elevator emergency stop, comprising
a brake pad to be pressed against a guide rail on which the brake pad slides, to generate a braking force by so that a cage of the elevator is stopped in response to an occurrence of emergency,
wherein the brake pad includes a cast iron, a plurality of grooves extending in a direction substantially perpendicular to the guide rail, and a tooth defined between the grooves to form a sliding surface for contacting the guide rail, and a depth of at least one of the grooves is not less than 3 mm and not more than 1.7 times of a width of the tooth.

2. A brake shoe for elevator emergency stop, comprising
a brake pad to be pressed against a guide rail on which the brake pad slides, to generate a braking force by so that a cage of the elevator is stopped in response to an occurrence of emergency,
wherein the brake pad includes a cast iron, a plurality of grooves extending in a direction substantially perpendicular to the guide rail, and a tooth defined between the grooves to form a sliding surface capable of contacting the guide rail, and mV²/nA≧4.5×10⁷ (J/m²) and (1−2σa/EαTₘₐₓ)/200≦x≦2h/3μₘₐₓ are satisfied when x is a depth of one of the groove, a mass of falling ones is m (kg), a velocity of cage at a start of braking is V (m/s), a number of braking pads is n, an area of the sliding surface is A (m²), a yielding point of the brake pad is σa (MPa), Young's modulus of the brake pad is E (MPa), a coefficient of linear thermal expansion is α (1/K), a melting point of the brake pad is Tₘₐₓ (° C.), a width of the tooth is h (m), and a maximum frictional coefficient between the guide rail and the sliding surface of the brake pad is μₘₐₓ.

3. The brake shoe according to claim 1, wherein the depth of the one of the groove is not less than 3 mm and not more than 8 mm.

4. The brake shoe according to claim 1, wherein the groove has one of semi-circular shape and U-shape.

5. The brake shoe according to claim 1, wherein the depths of the grooves are identical to each other.

6. The brake shoe according to claim 1, wherein each of upper and lower end portions of the sliding surface is inclined so that a distance between the guide rail and each of the upper and lower end portions increases in a direction toward respective one of the upper and lower end portions.

7. The brake shoe according to claim 1, wherein the width of the tooth at a front end side thereof is greater than the width of the tooth at a rear end side thereof.

8. The brake shoe according to claim 2, wherein the depth of the one of the groove is not less than 3 mm and not more than 8 mm.

9. The brake shoe according to claim 2, wherein the groove has one of semi-circular shape and U-shape.

10. The brake shoe according to claim 2, wherein the depths of the grooves are identical to each other.

11. The brake shoe according to claim 2, wherein each of upper and lower end portions of the sliding surface is inclined so that a distance between the guide rail and each of the upper and lower end portions increases in a direction toward respective one of the upper and lower end portions.

12. The brake shoe according to claim 2, wherein the width of the tooth at a front end side thereof is greater than the width of the tooth at a rear end side thereof.
